(19) United States
(12) Patent Application Publication
(10) Pub. No.: US 2007/0176873 A1
(43) Pub. Date: Aug. 2, 2007

(54) Display apparatus and filter controlling method

(75) Inventor: Misako Sato, Tachikawa-shi (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Kabushiki Kaisha Toshiba

(21) Appl. No.: 11/699,670

(22) Filed: Jan. 29, 2007

(30) Foreign Application Priority Data
Jan. 31, 2006 (JP) 2006-022945

(51) Int. Cl. G09G 3/36

(52) U.S. Cl. 345/90

(57) ABSTRACT

According to one embodiment, a display apparatus including a display screen, a first view-angle-controlled filter which is effective on a first direction of the display screen, a second view-angle-controlled filter which is effective on a second direction of the display screen, the second direction being orthogonal to the first direction, and a switching unit configured to allow the first view-angle-controlled filter and second view-angle-controlled filter to function exclusively and selectively.

### CROSS-REFERENCE TO RELATED APPLICATIONS

This application is based upon and claims the benefit of priority from Japanese Patent Application No. 2006-022945, filed Jan. 31, 2006, the entire contents of which are incorporated herein by reference.

### BACKGROUND

1. Field

One embodiment of the invention relates to techniques for automatically controlling a view-angle-controlledled filter that is preferably applied to a display apparatus of, for example, a personal computer.

2. Description of the Related Art

Various types of computers such as a desk-top type and a notebook type have been prevailing widely. A liquid crystal panel is often used as a display apparatus for these computers. Much effort has been made to improve the display apparatus so that users can easily see images on the display apparatus (see, for example, Jpn. Pat. Appln. KOKAI Publication No. 5-181115, which describes a technique for detecting the inclination of the liquid crystal display to automatically adjust its view angle depending on the inclination).

Computers called PDAs (Personal Digital Assistants) have also been spreading which can be easily operated, for example, even on the train. Notebook computers can also be driven by batteries and thus operated outside the home or office.

The liquid crystal panel of the computer that can be used outdoors needs not only to be easily seen by the user but also to be prevented from being easily seen by other people. A view-angle-controlledled filter is thus often installed, for example, to maintain a high visibility even when the display screen is viewed from outside its front in a vertical direction and to minimize the visibility from outside its front in a horizontal direction. This prevents the display screen from being viewed by a person next to the user while adjusting the view angle depending on the inclination.

Display apparatuses have also been commonly used which have a rectangular display screen the longitudinal direction of which can be set in either a vertical or horizontal direction. In this case, to adjust the view angle depending on the inclination or to prevent the display screen from being viewed by a person next to the user, it is necessary to determine whether the screen is set in the vertical or horizontal direction. However, the conventional filter control technique such as for the liquid crystal display apparatus in Jpn. Pat. Appln. KOKAI Publication No. 5-181115 does not take into account switching of direction of the liquid crystal display.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIGS. 1A and 1B are diagrams showing an example in which a display apparatus in accordance with the present invention is applied to a PDA;

FIGS. 2A and 2B are diagrams showing an example in which the display apparatus is applied to a desk-top computer;

FIGS. 3A and 3B are exemplary conceptual drawings illustrating the characteristics of a vertical filter and a horizontal filter provided in the display apparatus and serving as view-angle-controlledled filters;

FIG. 4 is an exemplary diagram showing a general configuration of a portion of the display apparatus which relates to a filter control operation;

FIG. 5 is an exemplary flowchart showing the principle of filter control operation of the display apparatus;

FIGS. 6A, 6B, and 6C are exemplary diagrams illustrating the basic principle of density adjustment executed by the vertical and horizontal filters provided in the display apparatus;

FIG. 7 is an exemplary diagram showing a general configuration of a portion of the display apparatus which relates to a second filter control operation (density adjustment); and

FIG. 8 is an exemplary flowchart showing the principle of the second filter control operation of the display apparatus.

### DETAILED DESCRIPTION

Various embodiments according to the invention will be described hereinafter with reference to the accompanying drawings. In general, according to one embodiment of the invention, a display apparatus including a display screen, a first view-angle-controlledled filter which is effective on a first direction of the display screen, a second view-angle-controlledled filter which is effective on a second direction of the display screen, the second direction being orthogonal to the first direction, and a switching unit configured to allow the first view-angle-controlledled filter and second view-angle-controlledled filter to function exclusively and selectively.

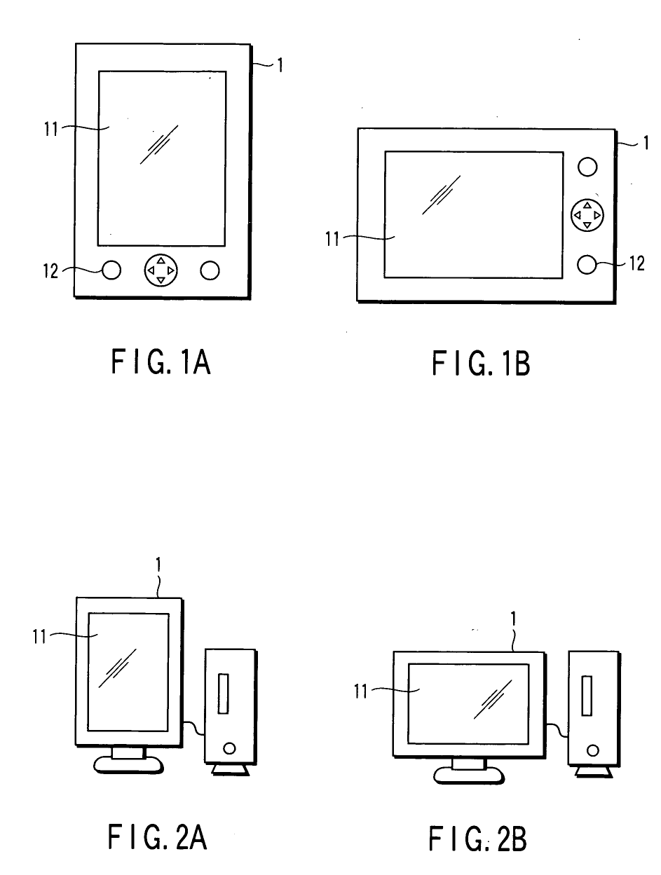

FIGS. 1A, 1B, 2A, and 2B are diagrams showing applications of a display apparatus in accordance with the present invention. FIGS. 1A and 1B show an application to PDA in which the display apparatus is integrated with an apparatus main body on its housing surface. FIGS. 2A and 2B show an application to a desk-top computer in which the display apparatus is installed independently of and around the periphery of the computer.

As shown in FIGS. 1A, 1B, 2A, and 2B, a display apparatus 1 in accordance with the present embodiment has a rectangular display surface 11 that can be set either in a vertically long position (FIGS. 1A and 2A) or in a horizontally long position (FIGS. 1B and 2B). Here, the rectangular display surface 11 is used in order to easily identify the vertical and horizontal directions. However, the present invention is not limited to this. The display apparatus 11 may have any shape, such as a square or a circle.

For the PDA shown in FIGS. 1A and 1B, an operation key 12 is also installed on the housing surface to set the direction in which the display surface 11 is set. The operation key 12 is operated to rotate a display image on the display device 11. For the desk-top computer shown in FIGS. 2A and 2B, a sensor is disposed on a pivoting shaft of a support mechanism that supports the display apparatus 1. The sensor detects how the display apparatus 1 is pivoting on the pivoting shaft, causing the display image on the display surface 11 to be automatically rotated.

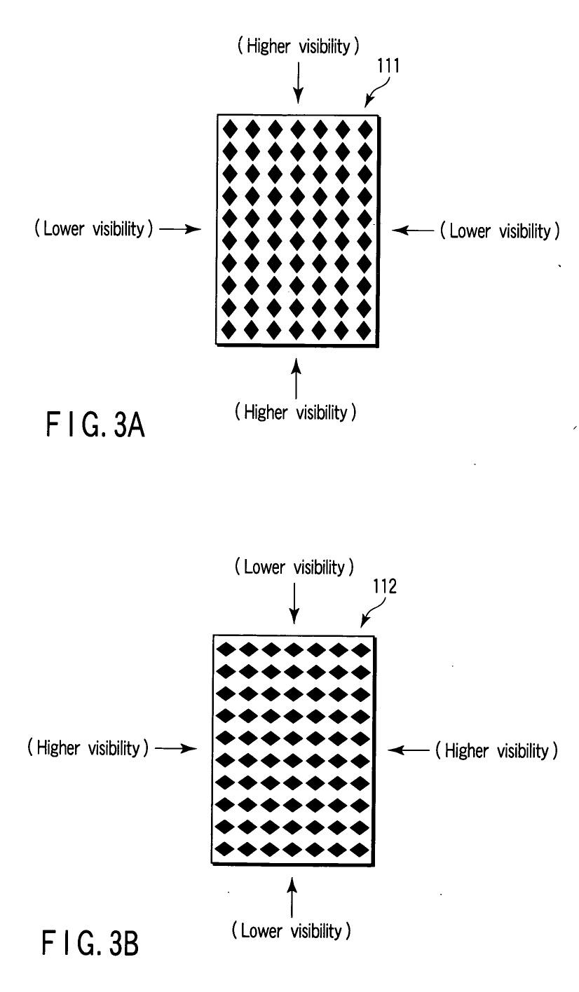

The display surface 11 of the display apparatus 1 is provided with two view-angle-controlledled filters, a vertical filter 111 and a horizontal filter 112, so as to avoid being viewed by a person next to the user of the computer. FIGS. 3A and 3B are conceptual drawings illustrating the characteristics of the vertical filter 111 and horizontal filter 112, serving as view-angle-controlledled filters.

As shown in FIGS. 3A and 3B, the vertical filter 111 and horizontal filter 112 have almost the same rectangular shape as that of the display surface 11. The vertical filter 111 is characterized by increasing the visibility from outside the front of the display surface 11 in a longitudinal direction, while reducing the visibility from outside the front of the display surface 11 in a direction orthogonal to the longitudinal direction (FIG. 3A). In contrast, the horizontal filter 112 is characterized by reducing the visibility from outside the front of the display surface 11 in the longitudinal direction, while increasing the visibility from outside the front of the display surface 11 in the direction orthogonal to the longitudinal direction (FIG. 3B). Consequently, in either case, the display surface 11 can be properly prevented from being viewed by a person next to the user by the following control: the vertical filter 111 is allowed to function if the display surface device is used with the display surface 11 set in the vertically long position as shown in FIGS. 1A and 2A, and the horizontal filter 112 is allowed to function if the display surface device is used with the display surface 11 set in the vertically long position as shown in FIGS. 1B and 2B.

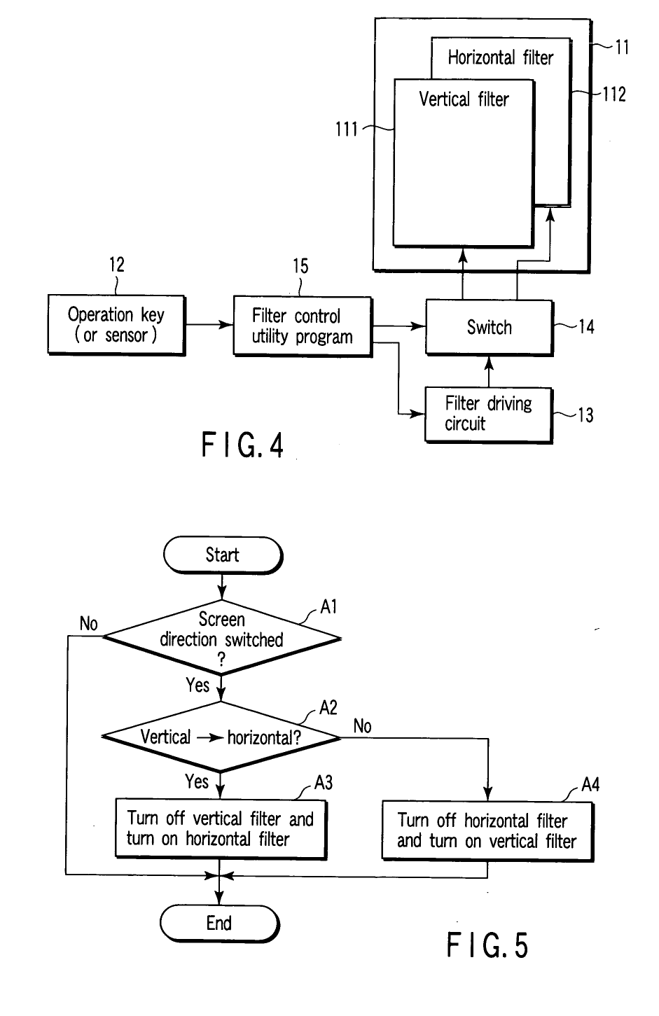

FIG. 4 is a diagram showing a general configuration of a portion of the display apparatus 1 which relates to a filter control operation. As shown in FIG. 4, in the display apparatus 1, the two view-angle-controlledled filters, the vertical filter 111 and horizontal filter 112, are superimposed on the display surface 11. A switch 14 is installed between the two view-angle-controlledled filters and a filter driving circuit 13 that drives the two view-angle-controlled filters.

The switch 14 allows the vertical filter 111 and horizontal filter 112 to function exclusively and selectively. More specifically, the switch 14 switches between (1) an operation of turning on the vertical filter 111, while turning off the horizontal filter 112 and (2) an operation of turning off the vertical filter 111, while turning on the horizontal filter 112. The operation of the switch is controlled by a filter control utility program 15.

When the operation key 12 is used to set the display surface 11 set in the vertically long position (or the sensor senses that the display apparatus 1 has pivoted from the horizontally long position to the vertically long position), the filter control utility program 15 allows the switch 14 to activate the vertical filter 111. When the operation key 12 is used to set the display surface 11 set in the horizontally long position (or the sensor senses that the display apparatus 1 has pivoted from the vertically long position to the horizontally long position), the filter control utility program 15 allows the switch 14 to activate the horizontal filter 112.

That is, the display apparatus 1 properly controls the filter so as to prevent the display surface 11 from being viewed by a person next to the user regardless of whether the display surface 11 is set in the vertically or horizontally long position.

FIG. 5 is a flowchart showing the principle of filter control operation of the display apparatus 1.

Upon recognizing that the direction of the display surface 11 has been switched (YES in block A1), the filter control utility program 15 determines whether the vertically long position has been switched to the horizontally long position or the horizontally long position has been switched to the vertically long position (block A2). If the vertically long position has been switched to the horizontally long position (YES in block A2), the filter control utility program 15 instructs the switch to turn off the vertical filter 111, while turning on the horizontal filter 112 (block A3). In contrast, if the horizontally long position has been switched to the vertically long position (NO in block A2), the filter control utility program 15 instructs the switch 14 to turn off the horizontal filter 112, while turning on the vertical filter 111 (block A4).

A description has been given of the filter control performed to prevent the display surface 11 from being viewed by a person next to the user regardless of whether the display surface 11 is set in the vertically or horizontally long position. Now, a description will be given of further filter control performed by the display apparatus 1 so as to maximally prevent a third person from taking a glimpse at the display surface depending on the inclination of the display surface 11 (regardless of its direction).

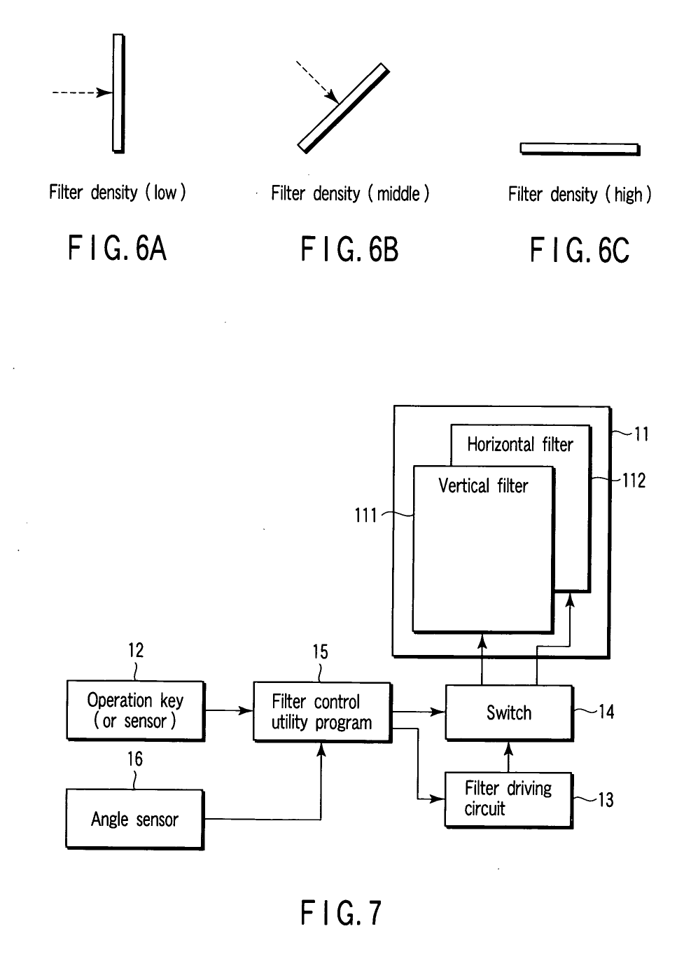

In this case, as shown in FIGS. 6A, 6B, and 6C, it is assumed that three levels of filter control are performed for an almost vertical position, an almost horizontal position, and a middle position of the display surface 11. The density of the vertical filter 111 or horizontal filter 112 is automatically controlled so as to set a high filter density when the display surface 11 is in an almost vertical position (FIG. 6A) and to increase the filter density as the display surface 11 approaches the horizontal direction (FIGS. 6B and 6C).

As described above, the display apparatus 1 performs control such that the vertical filter 111 functions when the display surface 11 is in the vertically long position, whereas the horizontal filter 112 functions when the display surface 11 is in the horizontally long position, that is, the display surface 11 is easy to see from outside its front in the vertical direction regardless of its direction. Thus, the filter density is increased as the display surface can be more and more easily viewed by a third person from the vertical direction. This enhances privacy protection.

To achieve this, the display apparatus 1 further comprises an angle sensor (acceleration sensor) 16. A detection signal output by the angle sensor 16 is supplied to the filter control utility program 15. On the basis of the detection signal, the filter control utility program 15 checks whether the inclination of the display surface 11 is in the state shown in FIG. 6A or 6B or 6C. The filter control utility program 15 then instructs the filter driving circuit 13 to adjust the density of the vertical filter 111 or horizontal filter 112 depending on the state in which the inclination is in.

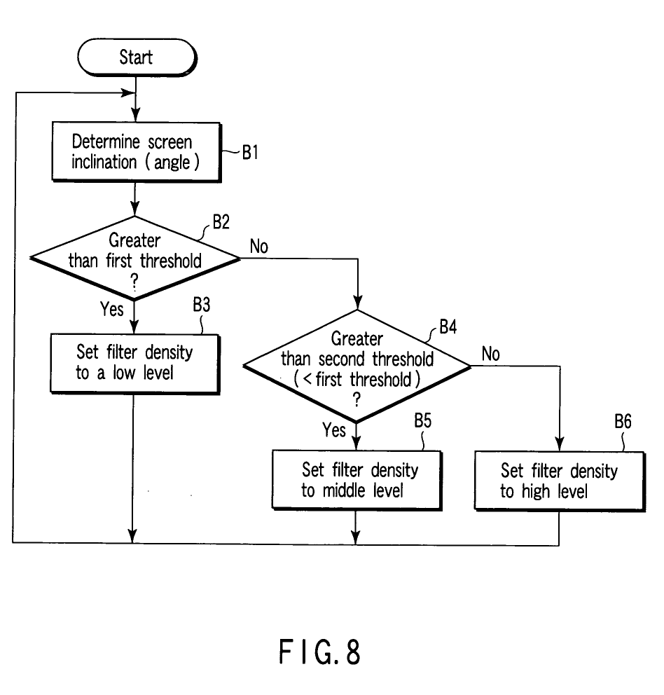

FIG. 8 is an exemplary flowchart showing the principle of second filter control (density adjusting) operation of the display apparatus 1.

The filter control utility program 15 determines the inclination of the display surface 11 (block B1). The filter control utility program 15 then checks whether or not the inclination is greater than a first threshold that makes it possible to determine whether or not the display surface is in an almost vertical position (block B2). If the inclination is greater than the first threshold (YES in block B2), the filter control utility program 15 instructs the filter driving circuit 13 to adjust the density of the vertical filter 111 or horizontal filter 112 to a low level (block B3).

If the inclination is not greater than the first threshold (NO in block B2), the filter control utility program 15 then checks whether or not the inclination is greater than a second threshold that makes it possible to determine whether or not the display surface is in an almost horizontal position (block B4). If the inclination is greater than the second threshold (YES in block B4), the filter control utility program 15 instructs the filter driving circuit 13 to adjust the density of the vertical filter 111 or horizontal filter 112 to a middle level (block B5). If the inclination is not greater than the second threshold (NO in block B4), the filter control utility program 15 instructs the filter driving circuit 13 to adjust the density of the vertical filter 111 or horizontal filter 112 to a high level (block B6).

As described above, the display apparatus 1 properly controls the filter so that not only a person next to the user is prevented from taking a glimpse at the display surface 11 regardless of whether the display surface 11 is set in the vertically or horizontally long position but a third person is also maximally prevented from taking a glimpse at the display screen depending on the inclination of the display surface 11.

The acceleration sensor has been illustrated as the angle sensor 16. However, if the display apparatus 1 is supported by the support mechanism shown in FIGS. 2A and 2B, a sensor may be disposed on a hinge that holds the display apparatus 1 at any inclination, in order to sense how the display apparatus 1 is held. Further, in the above example, the three levels of control are performed. However, the control may be at two or at least four levels, or the density may be linearly varied depending on the inclination determined via the angle sensor 16.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A display apparatus comprising:
a display screen;
a first view-angle-controlled filter which is effective on a first direction of the display screen;
a second view-angle-controlled filter which is effective on a second direction of the display screen, the second direction being orthogonal to the first direction; and
a switching unit configured to allow the first view-angle-controlled filter and second view-angle-controlled filter to function exclusively and selectively.

2. The display apparatus according to claim 1, further comprising:
an operation unit configured to set which of the first and second directions is set to align with a horizontal direction when the display screen is used; and
a control unit configured to allow the first view-angle-controlled filter to function if the first direction is set to align with the horizontal direction, and to allow the second view-angle-controlled filter to function if the second direction is set to align with the horizontal direction.

3. The display apparatus according to claim 1, further comprising:
a direction sensor which detects which of the first and second directions is set to align with a horizontal direction when the display screen is used; and
a control unit configured to allow the first view-angle-controlled filter to function if the first direction is detected to align with the horizontal direction, and to allow the second view-angle-controlled filter to function if the second direction is detected to align with the horizontal direction.

4. The display apparatus according to claim 3, further comprising a support mechanism including a pivoting shaft which allows the display screen to pivot while standing upright,
the direction sensor detects which of the first and second directions is aligned with the horizontal direction on the basis of how the display screen is pivoted by the pivoting shaft.

5. The display apparatus according to claim 1, further comprising an angle sensor which detects an inclination of the display screen,
the control unit controls a density of the first view-angle-controlled filter or second view-angle-controlled filter on the basis of a detection result provided by the angle sensor.

6. The display apparatus according to claim 5, wherein the control unit gradually increases the density of the first view-angle-controlled filter or second view-angle-controlled filter in inverse proportion to with the inclination detected by the angle sensor.

7. A filter controlling method for a display apparatus, the method comprising:
superimposing a first view-angle-controlled filter which is effective on a first direction of a display screen on a second view-angle-controlled filter which is effective on a second direction of the display screen, the second direction being orthogonal to the first direction; and
allowing the first view-angle-controlled filter and second view-angle-controlled filter to function exclusively and selectively depending on which of the first and second directions is set to align with a horizontal direction when the display screen is used.

8. The filter controlling method for a display apparatus according to claim 7, wherein the allowing allows the first view-angle-controlled filter to function if the first direction is set to align with the horizontal direction, and allows the second view-angle-controlled filter to function if the second direction is set to align with the horizontal direction.

9. The filter controlling method for a display apparatus according to claim 7, further comprising controlling a density of the first view-angle-controlled filter or second view-angle-controlled filter depending on an inclination of the display screen.

10. The filter controlling method for a display apparatus according to claim 9, wherein the controlling gradually increases the density of the first view-angle-controlled filter or second view-angle-controlled filter in inverse proportion to with the inclination.
